(19) United States
(12) Patent Application Publication
(10) Pub. No.: US 2002/0071184 A1
(43) Pub. Date: Jun. 13, 2002

(54) Etalon filter

(76) Inventors: Yasuhiro Nishi, Tokyo (JP); Kazuyo Mizuno, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/966,801

(22) Filed: Sep. 27, 2001

(30) Foreign Application Priority Data
Feb. 10, 2000 (JP) 2000-033314

(51) Int. Cl. G02F 1/03; G02F 1/07; G02B 27/00

(52) U.S. Cl. 359/578; 359/260

(57) ABSTRACT

An etalon filter of the invention is an etalon filter where the light transmission property depending on temperature is reduced, which is preferable as an optical device. An etalon filter (11) has a filter main body (1) where reflecting films are disposed on a light input side surface and a light output side surface of a light transmission medium. The etalon filter (11) is formed by disposing different linear expansion coefficient members (2) having a coefficient of linear expansion different from that of the light transmission medium in areas on both sides of the filter main body (1) except optical path length areas (4). The different linear expansion coefficient members (2) function as a stress applying part for applying stress to the light transmission medium, the stress is generated due to the difference of the coefficient of linear expansion from the light transmission medium when environmental temperature is changed, which reduces the light transmission property variation depending on temperature of the optical path areas (4) by the stress.

### BACKGROUND OF THE INVENTION

The present invention relates to an etalon filter for use in the field of optical communications.

The etalon filter is obtained by using a silica substrate as a light transmission medium and depositing a reflecting surface made of a dielectric multilayer film or metal film on both sides of the silica substrate. The etalon filter having this configuration is used as a gain equalizer for compensating the gain deviation of optical amplifiers. Additionally, the etalon filter is obtained by depositing a reflecting surface on both sides of a light transmission medium of the dielectric multiplayer film, for example. The etalon filter having this configuration is used as a Fabry-Perot optical resonator or wavelength-selective transmitting filter on semiconductor laser module.

### SUMMARY OF THE INVENTION

An etalon filter of the invention comprises:

a filter main body having a light transmission medium and reflecting films disposed on a light input side surface and a light output side surface of the light transmission medium; and

different linear expansion coefficient members having a coefficient of linear expansion different from that of the light transmission medium, the different linear expansion coefficient members disposed in areas on both sides of the filter main body except optical path areas.

### BRIEF DESCRIPTION OF THE DRAWINGS

Exemplary embodiments of the invention will now be described in conjunction with drawings in which:

FIG. 1A is a perspective view illustrating one embodiment of the etalon filter in the invention;

FIG. 1B is a sectional view illustrating the embodiment of the etalon filter in the invention;

FIG. 2A is a graph showing the temperature dependency of the etalon filter of the embodiment; and

FIG. 2B is a graph showing the temperature dependency of an conventional etalon filter.

### DETAILED DESCRIPTION

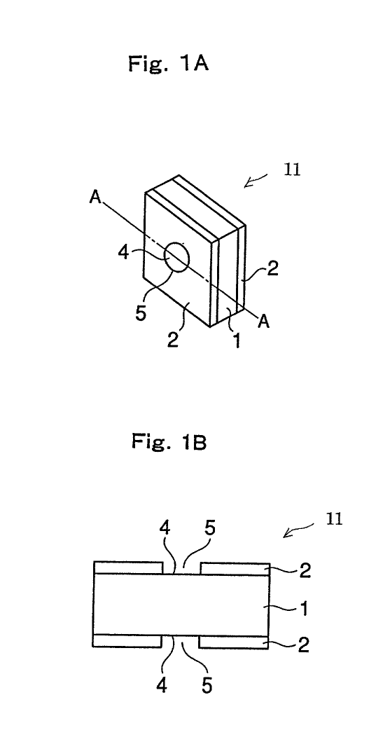

Hereafter, a specific embodiment of the invention will be described with reference to the drawings. FIG. 1A is a perspective view illustrating one embodiment of the etalon filter in the invention. FIG. 1B is a sectional view of a line A-A shown in FIG. 1A.

An etalon filter 11 shown in FIGS. 1A and 1B has a filter main body 1. The filter main body 1 is configured the same as the conventional etalon filter. The filter main body 1 has a light transmission medium and reflecting films disposed on a light input side and a light output side of the light transmission medium. The etalon filter 11 is formed to have different linear expansion coefficient members 2 in areas on both sides of the filter main body 1 except optical path areas 4, the different linear expansion coefficient members 2 has a coefficient of linear expansion different from that of the light transmission medium that constitutes the filter main body 1.

The different linear expansion coefficient members 2 function as a stress applying part for applying stress to the light transmission medium, the stress is generated due to the difference of the linear expansion coefficient from that of the light transmission medium when environmental temperature is changed. In addition, the different linear expansion coefficient members 2 reduce a light transmission property variation depending on temperature of the optical path areas 4 by the stress.

The light transmission medium of the filter main body 1 is formed of a silica substrate. The linear expansion coefficient of silica is 5.5×10⁻⁷K⁻¹. Furthermore, the different linear expansion coefficient members 2 are formed of stainless plates. The linear expansion coefficient of the stainless plates is 1.47×10⁻⁶K⁻¹. Moreover, BK7 may be used for the light transmission medium. Besides, glass copper, gold or nickel may be used for the different linear expansion coefficient members 2.

In addition, the different linear expansion coefficient member 2 has an optical path hole 5 in the optical path area 4 of the filter main body 1. The filter main body 1 is formed by attaching the different linear expansion coefficient members 2 shaped to have the optical path hole 5 to the filter main body 1 with an adhesive at room temperature. The etalon filter 11 has a configuration where the adhesive is not disposed in the optical path areas 4 by the configuration described above.

Hereafter, the operation of the different linear expansion coefficient members 2 in the etalon filter 11 will be described.

First, a variation Δd in a thickness d of the light transmission medium and a variation Δn in a refractive index n of the light transmission medium will be described. These values are expressed by the following expressions (1) and (2):

Δd=d[α₁ΔT−σ₀(α₂−α₁)ΔT] (1)

Δn=n_{T}ΔT (2),

where α₁ is a coefficient of linear expansion of the light transmission medium of the filter main body 1, α₂ is a coefficient of linear expansion of the different linear expansion coefficient members 2, d is a thickness of the light transmission medium, n_{T} is a temperature coefficient of the refractive index of the light transmission medium, and ΔT is an amount of temperature variation. Additionally, σ₀=2σ/(1−σ) in the expression (1), σ is a Poisson ratio.

In the case where lights enter the filter perpendicularly, an amount of the optical path length variation is set ΔL when temperature is changed by ΔT. This amount is expressed by expression (3):

ΔL=dΔn+nΔd+ΔnΔd (3).

The smaller this ΔL becomes, the smaller the optical path length variation is; the temperature dependency of the optical property is small. In the expression (3), d>0 and n>0, ΔnΔd is sufficiently small. Therefore, the expression (3) shows that the temperature dependency of the optical property can be reduced in case where Δd is set negative when Δn is positive and inversely Δd is set positive when Δn is negative.

In the etalon filter 11 described above, the light transmission medium of the filter main body 1 is formed of a silica substrate. A temperature dependency Δn of the refractive index of the silica substrate is 11.6×10⁻⁶k⁻¹, which is a positive value. Then, the inventor formed the etalon filter 11 by disposing the different linear expansion coefficient members 2 of stainless plates having a linear expansion coefficient greater than that of silica in areas on both sides of the filter main body 1 except the optical path areas 4. According to this configuration, Δd is set negative.

In the etalon filter 11 shown in FIGS. 1A and 1B, the different linear expansion coefficient members 2 expand greater than the light transmission medium of the silica substrate when temperature rises, for example. In accordance with this temperature increase, the different linear expansion coefficient members 2 apply stress (tensile stress) to the light transmission medium in the direction that the thickness of the light transmission medium becomes thinner in accordance with this expansion. Then, the operation of the different linear expansion coefficient members 2 extend over the optical path areas 4 where the different linear expansion coefficient members 2 are not disposed, which allows the thickness of the light transmission medium accompanying temperature to be reduced.

Accordingly, the etalon filter 11 can suppress an optical path length increase in the optical path areas 4 of the light transmission medium accompanying the temperature increase, which can suppress the optical property variation (transmittance variation) accompanying the temperature change.

Additionally, when temperature drops, the different linear expansion coefficient members 2 contract greater than the light transmission medium of the silica substrate in reverse to that described above. On this account, the different linear expansion coefficient members 2 apply stress (compressive stress) to the light transmission medium in the direction that the thickness of the light transmission medium becomes thicker. Consequently, the etalon filter 11 allows the thickness of the light transmission medium to be increased in accordance with temperature by the operation of the different linear expansion coefficient members 2. Accordingly, as similar to that described above, the etalon filter 11 can also suppress the optical property variation (transmittance variation) accompanying the temperature decrease.

Furthermore, the conventional etalon filter without the different linear expansion coefficient members 2 has been varied in the direction of increasing both the refractive index and the thickness of the light transmission medium in accordance with the temperature increase, for example, when the light transmission medium is made of a silica substrate. Moreover, the conventional etalon filter has been varied in the direction of reducing both the refractive index and the thickness of the light transmission medium in accordance with the temperature decrease.

That is, the light transmission medium of the etalon filter has the temperature dependency in the refractive index and the thickness and thus both the refractive index and the thickness were varied in accordance with the temperature change as described above. Then, in the conventional etalon filter, the optical path length has been changed in accordance with the thickness change and an FSR (Free Spectral Range) has been varied depending on temperature. On this account, an optical amplifier having the conventional etalon filter as a gain equalizer, for example, has had a problem that the gain flatness is decreased due to the change in the environmental temperature to be used.

Additionally, in a Fabry-Perot optical resonator formed of the conventional etalon filter, a problem has arisen that the optical resonance property is changed when temperature in an operational environment is changed or heat is generated in operating a semiconductor laser. Furthermore, also in a wavelength-selective transmitting filter formed of the conventional etalon filter, a problem has arisen that its wavelength property is varied due to the change in the environmental temperature to be used.

On the other hand, the etalon filter 11 of one embodiment of the invention can suppress the optical property variation (transmittance variation) accompanying the temperature change as described above. Therefore, it is a preferred etalon filter as an optical device.

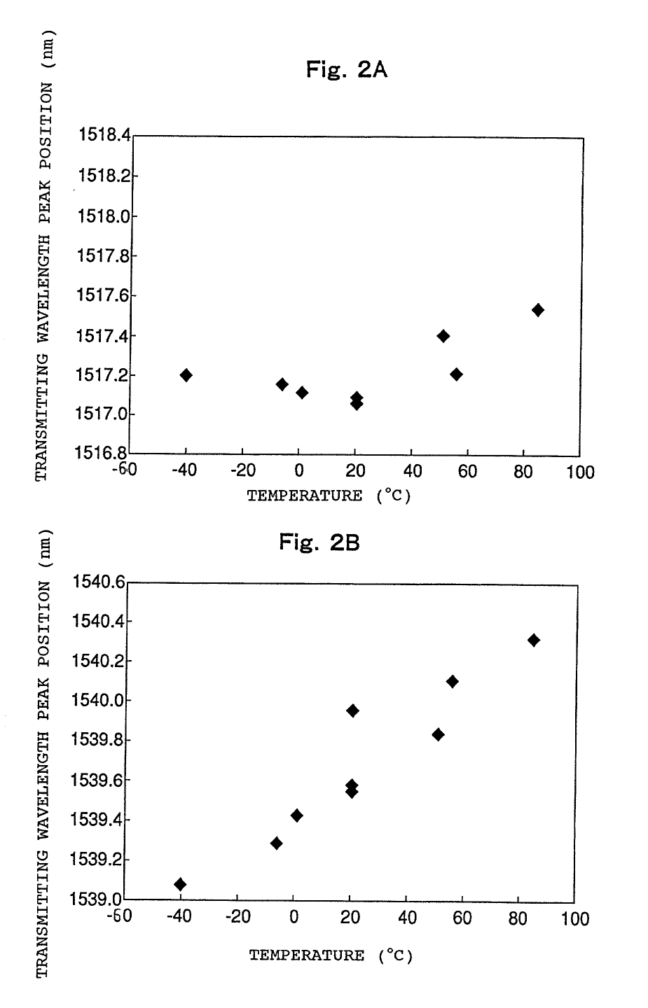

FIG. 2A shows results that transmittance profiles were measured within a range of temperatures of −40° C. to 85° C. on the etalon filter 11. The measured results determined how peak positions (transmitting wavelength peak positions) of the filter main body 1 vary depending on temperature.

Additionally, FIG. 2B shows results that the same study was done as FIG. 2A. The measured results determined variation conditions of the transmitting wavelength peak positions depending on temperatures on the conventional etalon filter.

As apparent from FIGS. 2A and 2B, the maximum vale of the transmitting wavelength peak position variation in the aforesaid temperature range was 0.48 nm in the etalon filter 11 whereas it was 1.24 nm in the conventional etalon filter. That is, in the etalon filter 11, the range of the peak position variation is about 40% of the conventional etalon filter; the optical property variation accompanying the temperature change was improved to a great extent.

As described above, the etalon filter 11 can reduce the change accompanying the refractive index temperature dependency of the optical path length of the optical path areas 4 of the light transmission medium by the change accompanying the temperature dependency of the thickness corresponding to the operation of the different linear expansion coefficient members 2. That is, the etalon filter 11 suppresses the optical property variation accompanying the temperature change to a great degree.

Additionally, as shown in FIGS. 1A and 1B, the etalon filter 11 does not have an adhesive in the optical path areas 4. On this account, the etalon filter 11 does not need to consider the optical property variation due to the expansion, contraction or long-term chemical change of adhesives.

Accordingly, when the etalon filter 11 is used to form a gain equalizer for an optical amplifier, an optical amplifier that can maintain the gain flatness even though the environmental temperature to be used is changed can be configured, which can reduce the temperature dependency of the gain flatness in the optical amplifier.

Additionally, when a Fabry-Perot optical resonator is formed of the etalon filter 11, an optical resonator can be configured in which the optical resonance property variation is small even though temperature in an operational environment is changed or heat is generated in operating a semiconductor laser. Furthermore, a wavelength-selective transmitting filter is formed of the etalon filter 11, a wavelength-selective transmitting filter can be configured in which the wavelength property variation is small even though temperature in an operational environment is changed.

Moreover, the invention is not limited to the embodiment, which can adopt various embodiments. Besides, the different linear expansion coefficient members 2 are properly formed corresponding to a refractive index temperature coefficient of the light transmission medium that constitutes the etalon filter. For example, the different linear expansion coefficient members 2 may be formed of glass plates other than metal.

That is, the different linear expansion coefficient members 2 are formed of a material having a coefficient of linear expansion greater than that of the light transmission medium when the refractive index temperature coefficient of the light transmission medium is positive as silica, for example. On the other hand, it is formed of a material having a coefficient of linear expansion smaller than that of the light transmission medium when the refractive index temperature coefficient of the light transmission medium is negative as crystal (Δn=−6×10⁻⁵). The application of such configurations can exert the effect of the invention exactly.

What is claimed is:

1. An etalon filter comprising:
a filter main body having a light transmission medium and reflecting films disposed on a light input side surface and a light output side surface of the light transmission medium; and
different linear expansion coefficient members having a coefficient of linear expansion different from that of said light transmission medium, the different linear expansion coefficient members disposed in areas on both sides of the filter main body except optical path areas.

2. The etalon filter according to claim 1, wherein the different linear expansion coefficient members function as a stress applying part for applying stress to said light transmission medium, the stress is generated due to difference of a coefficient of linear expansion from that of said light transmission medium when environmental temperature is changed.

3. The etalon filter according to claim 1, wherein the different linear expansion coefficient members function as a light transmission property variation reducing part for reducing light transmission property variation depending on temperatures of the optical path areas by stress applying to the light transmission medium when environmental temperature is changed.

4. The etalon filter according to claim 1, wherein an adhesive for attaching the different linear expansion coefficient members to surfaces of the etalon filter is not disposed in the optical path areas.

5. The etalon filter according to claim 1, wherein the different linear expansion coefficient members are glass plates.

6. The etalon filter according to claim 1, wherein the different linear expansion coefficient members are metal plates.

7. The etalon filter according to claim 1, wherein the different linear expansion coefficient members are glass plates.
